(19) United States
(12) Patent Application Publication
(10) Pub. No.: US 2026/0163084 A1
(43) Pub. Date: Jun. 11, 2026

(54) METHOD FOR DISCHARGING LITHIUM-ION BATTERY

(71) Applicant: National University of Tainan, Tainan City (TW)

(72) Inventors: Chia-Chin CHANG, Tainan City (TW); Li-Jane HER, Kaohsiung City (TW)

(73) Assignee: National University of Tainan, Tainan City (TW)

(21) Appl. No.: 19/025,072

(22) Filed: Jan. 16, 2025

(30) Foreign Application Priority Data
Dec. 10, 2024 (TW) 113147941

(51) Int. Cl. H01M 10/44; H01M 10/54; H01M 50/317; H01M 50/574

(52) U.S. Cl. CPC H01M 10/44; H01M 50/317; H01M 50/574; H01M 10/54; H01M 2200/20

(57) ABSTRACT

Provided is a method of discharging lithium-ion battery, which comprises placing a lithium-ion battery to be discharged in a discharge solution to obtain a discharged lithium-ion battery. The discharge solution includes 0.5 M to 2 M of an alkaline solution and 0.1 M to 3 M of an auxiliary agent. The auxiliary agent includes acetate, citrate, chloride, sulfate, phosphate, oxalate, organic acid, or any combinations thereof. The discharge solution can efficiently and safely discharge the lithium-ion battery and avoid generation of toxic chlorine gas or corrosion of its case caused by chlorine ions, thereby solving the problems of dissolution of internal materials of battery, electrode sticking, and difficulties in subsequent recycling.

### CROSS-REFERENCE TO RELATED APPLICATION

Pursuant to 35 U.S.C. § 119 (a), this application claims the benefit of the priority to Taiwan Patent Application No. 113147941 filed on Dec. 10, 2024. The content of the prior application is incorporated herein by its entirety.

### BACKGROUND OF THE INVENTION

### 1. Field of the Invention

The present invention is related to a method for discharging a lithium-ion battery, particularly to a method for efficiently and safely discharging a waste lithium-ion battery.

### 2. Description of the Prior Arts

Due to the advantages of large specific capacities, high voltages, long lifespan, and no memory effects, lithium-ion batteries have currently been widely used for portable electronic products such as smart phones and laptops, and can also be used for various energy storage systems and electric vehicles and motorcycles. As demands for electric vehicles and motorcycles and renewable energy increase year by year, the usage of lithium-ion batteries subsequently has surged. Lithium-ion batteries typically have a lifespan of 5 to 15 years, meaning there will be large amounts of waste lithium-ion batteries in the future, attracting attention to environmental protection and resource recycling from various sectors. Waste lithium-ion batteries contain various components of metals or precious metals (for example, lithium, cobalt, nickel, manganese, and aluminum). If the components penetrate into the soil and water resources without proper treatment, they can cause potential harm to ecosystems and human health. The electrolyte of lithium-ion batteries also contains volatile organic compounds (VOCs) and may cause long-term pollution to the environment as well.

With the rise of environmental protection awareness, the recycling of waste lithium-ion batteries has become an increasingly important issue. The conventional recycling for waste lithium-ion batteries includes hydrometallurgy and pyrometallurgy. Hydrometallurgy is generally more selective and environmentally friendly, and can effectively extract precious metals such as lithium and cobalt, while pyrometallurgy has an advantage in processing speed but may produce more pollutants. No matter which method of metallurgy is adopted, a crucial discharge procedure for waste lithium-ion batteries should be conducted first. The discharge procedure not only reduces safety risks in subsequent processes, such as short circuit, explosion, or fire disaster during disassembly process, and also improves the overall efficiency of recycling waste lithium-ion batteries. Besides, the discharged waste lithium-ion batteries can be pyrolyzed and crushed more safely, ensuring various metals can be effectively separated and recycled.

The conventional discharge method is to immerse a waste lithium-ion battery in a sodium chloride (NaCl) solution, wherein the positive and negative electrode metals of the waste lithium-ion battery are used as the anode and cathode, the sodium chloride solution is used as the electrolyte, and the waste lithium-ion battery is used as the power source to consume the remaining power thereof through electrolysis reaction. This conventional method is easy to operate and low-cost, but its potential environmental hazards cannot be ignored. During the discharge process, chlorine ions will release toxic chlorine gas on the surface of the positive terminal of the battery. A large amount of chlorine gas will destroy the passivation film of the aluminum positive electrode, causing the exposed aluminum to discharge as an active metal, leading to the dissolution of positive terminal and materials inside the battery, resulting in the incomplete discharge and environmental problems such as large amounts of metal dissolution.

To solve these problems, China Invention Patent Publication No. CN110635185A discloses a discharge method of waste lithium-ion batteries, which makes a waste lithium-ion battery in direct contact with a sacrificial anode, such as magnesium, titanium, manganese, zinc, chromium, iron, and cadmium. Since the sacrificial anode is in contact with the positive electrode, the preferential oxidation and dissolution of the sacrificial anode during the discharge process can help avoid the precipitation of chlorine gas and thereby avoid the corrosion of the passivation film on the surface of the positive electrode by chlorine gas. It also solves the problems of dissolution of the positive electrode terminal or the positive electrode tab when discharging the battery with the sodium chloride solution in the prior art. However, the use of sacrificial anode for discharge treatment produces wastewater of magnesium, titanium, manganese, zinc, chromium, iron, and cadmium and causes the post-processing and recovery problems, so there is still a need for improvement.

In view of the shortcomings in the prior art, there is still a need to develop a discharge method different from the past, so as to solve the problems of incomplete discharge, dissolution of internal materials of the battery, and difficulties in subsequent recycling and processing when using the sodium chloride solution to dispose the waste lithium-ion batteries.

### SUMMARY OF THE INVENTION

One objective of the present invention is to discharge lithium-ion batteries with an efficient and safe method, thereby improving the safety of subsequent recycling or disposal of waste lithium-ion batteries.

Another objective of the present invention is to make the covers of the lithium-ion batteries opened during a discharge treatment, to effectively reduce the dissolution of the internal materials of the batteries, and to avoid electrode sticking problems.

In order to achieve the aforementioned objectives, the present invention provides a method for discharging a lithium-ion battery, comprising placing a lithium-ion battery to be discharged in a discharge solution to obtain a discharged lithium-ion battery, wherein the discharge solution contains 0.5 molarity (M) to 2 M of an alkaline solution and 0.1 M to 3 M of an auxiliary agent, and the auxiliary agent contains acetate, citrate, chloride, sulfate, phosphate, oxalate, an organic acid, or any combinations thereof.

By adopting a discharge solution with specific composition and concentration, the present invention can convert the electrochemical reaction of the battery positive electrode from the precipitation of chlorine gas into the oxidation of the anode with production of oxygen and discharge a lithium-ion battery efficiently and safely, thereby avoiding the generation of toxic chlorine gas in the past or the corrosion caused by chlorine ions on the surface of the positive terminal or the case of the lithium-ion battery. In addition, the discharge solution makes the upper end cover opened during discharging and solves the problems caused by conventional discharge methods, including dissolution of the internal materials of the battery, electrode sticking, and difficulties in the subsequent recycling and disposal process.

In the discharge solution, the alkaline solution contains sodium hydroxide solution, potassium hydroxide solution, calcium hydroxide solution, or any combinations thereof. Optionally, the concentration of the alkaline solution may be 0.5 M, 0.6 M, 0.7 M, 0.8 M, 0.9 M, 1 M, 1.1 M, 1.2 M, 1.3 M, 1.4 M, 1.5 M, 1.6 M, 1.7 M, 1.8 M, 1.9 M, 2 M, or the concentration of the alkaline solution may fall within the ranges formed by any two of the above values. In one of the embodiments, the concentration of the alkaline solution may be 0.5 M to 1.75 M.

In the discharge solution, the concentration of the auxiliary agent May be 0.1 M, 0.2 M, 0.3 M, 0.4 M, 0.5 M, 0.6 M, 0.7 M, 0.8 M, 0.9 M, 1 M, 1.1 M, 1.2 M, 1.3 M, 1.4 M, 1.5 M, 1.6 M, 1.7 M, 1.8 M, 1.9 M, 2 M, 2.1 M, 2.2 M, 2.3 M, 2.4 M, 2.5 M, 2.6 M, 2.7 M, 2.8 M, 2.9 M, 3 M, or the concentration of the auxiliary agent may fall within the ranges formed by any two of the above values. In one of the embodiments, the concentration of the auxiliary agent may be 0.5 M to 2.8 M. It can be understood that when the auxiliary agent contains two or more salts and/or organic acids, the concentration of the auxiliary agent refers to the sum of the individual concentrations of salts and/or organic acids.

The auxiliary agent contains acetates (such as sodium acetate and potassium acetate), citrates (such as sodium citrate and potassium citrate), chlorides (such as sodium chloride and potassium chloride), sulfates (such as sodium sulfate and potassium sulfate), phosphates (such as sodium phosphate and potassium phosphate), oxalates (such as sodium oxalate and potassium oxalate), organic acids (such as formic acid, oxalic acid, ethylenediaminetetraacetic acid, alkyl sulfonic acids with 1 to 4 carbon atoms [such as methanesulfonic acid, ethanesulfonic acid, propanesulfonic acid, and butanesulfonic acid], hydroxycarboxylic acids [such as lactic acid, tartaric acid, and gluconic acid], amino acids [such as glycine and glutamic acid], dicarboxylic acids, and polycarboxylic acids [such as succinic acid]), or any combinations thereof, but is not limited thereto.

In one of the embodiments, the concentration of acetate, citrate, chloride, sulfate, phosphate, oxalate, and organic acids may independently be 0.05 M, 0.06 M, 0.07 M, 0.08 M, 0.09 M, 0.10 M, 0.11 M, 0.12 M, 0.13 M, 0.14 M, 0.15 M, 0.16 M, 0.17 M, 0.18 M, 0.19 M, 0.20 M, 0.30 M, 0.40 M, 0.50 M, 0.60 M, 0.70 M, 0.80 M, 0.90 M, 1.00 M, 1.50 M, 2.00 M, 2.50 M, 3.00 M, or fall within the ranges formed by any two of the above values, and the concentration of various auxiliary agents may be the same or not. In one of the embodiments, the concentration of the auxiliary agent may be 0.05 M to 0.20 M or 1.00 M to 2.00 M.

In another embodiment, the concentration of acetate, citrate, chloride, sulfate, phosphate, and oxalate may independently be 1.00 M to 2.00 M, and the concentration of various salts may be the same or not.

Optionally, the concentration of the chloride may be 0.20 M or below, or 0.01 M to 0.20 M. By controlling the concentration of the chloride, it is helpful to mitigate the release of intensive chlorine gas during discharging, thereby avoiding problems of incomplete discharge, serious dissolution of positive electrode materials, and large amounts of metal ions dissolved in the discharge solution. Preferably, the concentration of the chloride may be 0.01 M to 0.12 M.

In one of the embodiments, the discharge solution contains 1.25 M to 1.5 M sodium hydroxide solution, 0.40 M to 0.60 M acetate, and 0.05 M to 0.5 M citrate.

The usage of the discharge solution may generally be controlled to a level sufficient to make the liquid level of the discharge solution higher than the level of the upper end cover of the lithium-ion battery, so that the entire lithium-ion battery can be immersed in the discharge solution for an efficient and safe discharge treatment. In the method of the present invention, the mass ratio of the discharge solution to the lithium-ion battery to be discharged is 1:0.5 to 1:5. Optionally, the mass ratio of the discharge solution to the lithium-ion battery to be discharged may be 1:0.5, 1:0.6, 1:0.7, 1:0.8, 1:0.9, 1:1, 1:1.1, 1:1.2, 1:1.3, 1:1.4, 1:1.5, 1:1.6, 1:1.7, 1:1.8, 1:1.9, 1:2, 1:3, 1:4, 1:5, or the mass ratio may fall within the range formed by any two of the above ratios.

Besides, the discharge solution may be poured into a dedicated container during the discharge process, making the positive and negative electrodes of the battery to be discharged in direct contact with the discharge solution to discharge the battery. Specifically, the liquid level of the discharge solution may be higher than the level of the upper end cover of the lithium-ion battery for an efficient and safe discharge treatment.

Optionally, the lithium-ion battery to be discharged may be placed in the discharge solution for 12 hours to 240 hours to obtain a discharged lithium-ion battery. After discharging by the method of the present invention, the voltage of the discharged lithium-ion battery may be 1 volt or less, or the change rate of the voltage of the discharged lithium-ion battery after one day of discharge may be 3% or less, ensuring that the lithium-ion battery has been fully discharged and the voltage has dropped to a stable value, and no safety risks would arise in the subsequent recycling process of pyrolysis and crushing for lithium-ion batteries.

Optionally, the discharge method of the present invention for lithium-ion batteries may be applied to various lithium-ion batteries without special restrictions. For example, the lithium-ion battery to be discharged has an aluminum safety vent disposed below the positive electrode of the lithium-ion battery to be discharged. In addition, the lithium-ion battery to be discharged may have a current interrupt device (CID) disposed below the aluminum safety vent.

It can be understood that the aluminum safety vent is designed to improve the safety of the lithium-ion battery. When the internal pressure of the lithium-ion battery is higher than the predetermined pressure, the aluminum safety vent opens to release the internal gas; when the internal pressure is lower than the predetermined pressure, the aluminum safety vent closes and blocks external gas from entering the lithium-ion battery. The internal pressure would rise due to gas generated after overcharging or in process with safety concerns until the current interrupt device is triggered. With the installation of the current interrupt device, the lithium-ion battery can no longer discharge by physical means, discharging with an external load, or chemical means, immersing in a conductive salt solution. Additionally, under oxidation conditions, the aluminum or aluminum alloy material is anodically polarized to form a very thin protective layer (passivation film) on the surface of the metallic positive electrode. The passivation film will hinder the corrosive effect of the chemical solution. As a result, the desired discharge cannot be performed once the current interrupt device is triggered, which fails to reduce the safety risks effectively. By utilizing the discharge solution of the present invention to discharge a lithium-ion battery equipped with an aluminum safety vent and a current interrupt device, the aluminum safety vent can still be corroded successfully to open the cover, and the lithium-ion battery can be fully discharged efficiently and safely, thereby improving the safety in the subsequent recycling or disposal process.

The pH value of the discharge solution is 13 or above. Even after discharging the lithium-ion batteries, the pH value of the discharge solution can remain at 13 or above. Accordingly, the discharge method for lithium-ion batteries of the present invention can recycle the discharge solution, achieve effective reuse of resources, and meet the needs of sustainable development.

By means of preparing a solution that is stable and less corrosive to the materials inside the battery (especially the positive electrode material, such as the positive electrode terminals or tabs), it can avoid the generation of harmful gases during the discharge process, and effectively reduce corrosion of the positive terminal material. The addition of appropriate auxiliary agents is further useful to enhance the stability of the discharge solution, thereby reducing the unnecessary dissolution of metal ions (iron, nickel, and cobalt ions), so that the discharge solution can maintain its discharge capability after multiple uses, reducing material waste. Accordingly, the discharge method for lithium-ion batteries not only improves discharge efficiency and discharge safety but also effectively reduces the corrosion of the battery's internal materials by the discharge solution, prevents electrode sticking, and the dissolution of metal ions leading to environmental pollution, and increases recycling efficiency.

Optionally, the lithium-ion batteries may be placed vertically or horizontally in the dedicated container with the discharge solution, facilitating the rapid gas emission during discharge and preventing leakage or explosion caused by gas and pressure accumulation. In other embodiments, porous materials can also be used as separators to ensure uniform distribution of the discharge solution, further improving discharge efficiency.

Compared with the existing conventional discharge method, the discharge solution used in the discharge method for lithium-ion batteries of the present invention is more stable and less affected by light, temperature, pH value, and other metal ions, ensuring the discharge conditions are easier to be controlled during the discharge process. Besides, water is oxidized first, avoiding the precipitation of chlorine gas and metal dissolution, thus effectively reducing and mitigating the metal ion pollutions.

### BRIEF DESCRIPTION OF THE DRAWING

FIG. 1 is a flow chart of a method for discharging a lithium-ion battery.

### DETAILED DESCRIPTION OF THE PREFERRED EMBODIMENTS

Several methods for discharging lithium-ion batteries are listed below as examples to illustrate the embodiments of the present invention. A person skilled in the art can easily realize the advantages and effects of the present invention from the following examples and comparative examples. The descriptions proposed herein are just preferable embodiments for the purpose of illustrations only, not intended to limit the scope of the present application. Various modifications and variations could be made in order to practice or apply the present invention without departing from the spirit and scope of the present application.

### Discharge Solution

Discharge solution A is a mixed solution containing 1.25 M potassium hydroxide, 0.5 M sodium acetate, and 0.17 M sodium chloride, with a pH value of 13.29.

Discharge solution B is a mixed solution containing 1.25 M potassium hydroxide, 1.5 M sodium acetate, 1 M potassium citrate, 0.08 M sodium chloride, and 0.12 M oxalic acid, with a pH value of 13.52.

Discharge solution C is a mixed solution containing 1.5 M potassium hydroxide, 0.5 M sodium acetate, 1 M potassium citrate, and 0.06 M oxalic acid, with a pH value of 13.75.

Discharge solution D is a mixed solution containing 1.5 M potassium hydroxide, 1 M sodium acetate, 0.17 M sodium chloride, and 0.12 M oxalic acid, with a pH value of 13.11.

Discharge solution E is a mixed solution containing 1.5 M potassium hydroxide, 1.5 M sodium acetate, 0.5 M potassium citrate, and 0.08 M sodium chloride, with a pH value of 13.29.

Discharge solution F is a mixed solution containing 1.75 M potassium hydroxide, 0.5 M sodium acetate, 0.5 M potassium citrate, 0.08 M sodium chloride, and 0.12 M oxalic acid, with a pH value of 13.31.

Discharge solution G is a mixed solution containing 1.75 M potassium hydroxide, 1 M sodium acetate, and 1 M potassium citrate, with a pH value of 13.62.

Discharge solution H is a mixed solution containing 1.75 M potassium hydroxide, 1.5 M sodium acetate, and 0.06 M oxalic acid, with a pH value of 13.52.

Discharge solution I is a mixed solution containing 1.25 M potassium hydroxide, 1 M sodium acetate, 0.5 M potassium citrate, and 0.06 M oxalic acid, with a pH value of 13.46.

Other discharge solutions:
1. 1 M sodium chloride solution with a pH value of 8.15;
2. 1 M sodium sulfate (Na₂SO₄) solution with a pH value of 6.47;
3. 1 M dipotassium hydrogen phosphate (K₂HPO₄) solution with a pH value of 9.15;
4. 2 M citric acid solution;
5. 2 M sodium carbonate (Na₂CO₃) solution;
6. 0.12 M oxalic acid solution.

### Methods for Discharging Lithium-Ion Batteries

Hereinafter, the waste lithium-ion batteries were adopted as the lithium-ion batteries to be discharged, and each waste lithium-ion battery was discharged through the method described below to evaluate the discharge effects of different discharge solutions on the waste lithium-ion batteries. The discharge method was described below.

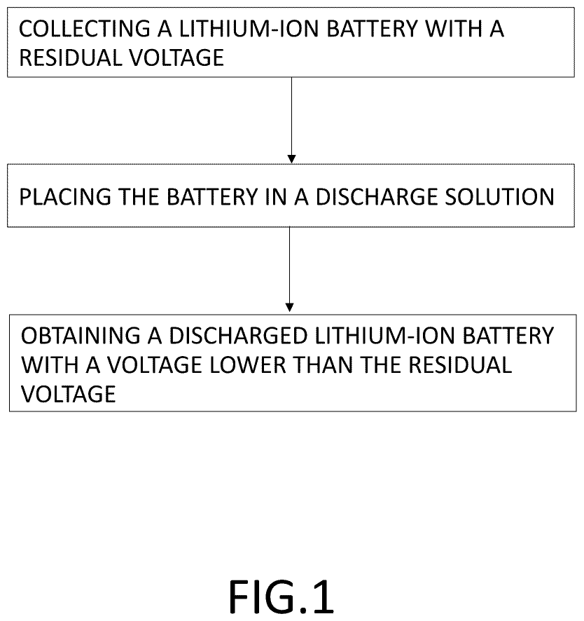

With reference to FIG. 1, the waste lithium-ion batteries were collected, and the residual voltage of each battery was measured in advance, as listed in Table 1 below. The model of the waste lithium-ion battery can be either 18650 or 21700, with no special restrictions. An aluminum safety vent, made of aluminum or aluminum alloy, is disposed on the upper end cover of the waste lithium-ion battery, and a current interrupt device is disposed below the aluminum safety vent.

A dedicated container for the waste lithium-ion battery was provided with an upward-facing opening to facilitate gas emission and prevent leaks or explosions caused by gas and pressure accumulation. Later, the various aforementioned discharge solutions were poured into each dedicated container, with the amount of the discharge solution calculated by a 1:1.6 mass ratio relative to the waste lithium-ion battery. Subsequently, the cylindrical waste lithium-ion battery was placed vertically into a dedicated container with the discharge solution, ensuring the negative electrode was in contact with the bottom and the positive electrode faced the opening of the container. At this time, the liquid level of the discharge solution was higher than the positive electrode cover, i.e., the upper end cover, of the battery, ensuring both the positive and negative electrodes were in direct contact with the discharge solution. After immersing the waste lithium-ion battery in the discharge solution at room temperature for a period of time, a discharged waste lithium-ion battery was obtained.

The type of discharge solutions and the immersion time of the waste lithium-ion battery in the discharge solutions for discharge in examples 1 to 28 (E1 to E28) and comparative examples 1 to 13 (C1 to C13) are shown in Table 1 and Table 2.

9 It should be noted that C1 and C2 involved discharge treatment of the same waste lithium-ion battery to be discharged, with the only difference being the duration of discharge while immersed in 1 M NaCl solution. Likewise, C3 and C4 involved discharge testing of the same waste lithium-ion battery to be discharged, but with differing discharge durations in the 1 M Na₂SO₄ solution. C5 and C6 pertained to the discharge testing of the same waste lithium-ion battery to be discharged, but with differing discharge durations in the 1 M K₂HPO₄ solution. These variations were designed to facilitate the subsequent evaluation of the discharge effect of each group.

### Test Example 1: Discharge Efficiency

A multimeter was used to measure the residual voltage of the waste lithium-ion batteries before discharge in each example and comparative example, shown as “voltage before discharge” in Table 1 and Table 2 below. In addition, a multimeter was used to measure the voltage of the pole coil of the discharged waste lithium-ion battery in each example and comparative example, shown as “voltage after discharge” in Table 1 and Table 2 below.

For the waste lithium-ion batteries with higher residual voltage, as shown in Table 1 below, after immersing the batteries of E1 to E20 in different discharge solutions for 36 hours, the discharge could be completed with high efficiency, making the voltage of the waste lithium-ion batteries dropped to 1 volt (V) or below. In comparison, the waste lithium-ion batteries in C1, C3, C5, and C7 to C9 could not be discharged effectively after being immersed in the discharge solutions for 36 hours, and their voltage was still as high as 3.5 V or above. After the waste lithium-ion batteries in C1, C3, and C5 were immersed in the discharge solutions for 144 hours, although the voltage in C2 and C4 after discharge could drop to 1 V or below, the voltage of C6 after discharge still exceeded 2 V. Obviously, the discharge efficiency of E1 to E20 is significantly better than that of C1 to C9.

For the waste lithium-ion batteries with lower residual voltage, as shown in Table 2 below, after immersing the waste lithium-ion batteries from E21 to E28 in different discharge solutions for 36 hours, the discharge could still be conducted with high efficiency, further decreasing the voltage of the waste lithium-ion batteries. On the contrary, the voltage of the waste lithium-ion battery in C12 did not change significantly after it was immersed in a 1 M K₂HPO₄ solution for 36 hours. Even if the battery continued to be immersed for a long time for 144 hours, the voltage of C13 after discharge was not significantly different from its initial residual voltage. It can be seen that the K₂HPO₄ solution is not a suitable component of the discharge solution and cannot effectively discharge the waste lithium-ion batteries.

From the results of this test example, it can be seen that the discharge efficiency of C7 to C9 is obviously poor, and the NaCl solution, the Na₂SO₄ solution, and the K₂HPO₄ solution are not suitable for discharging the waste lithium-ion batteries, so the following test examples 2 to 4 did not include an evaluation of C7 to C9.

### Test Example 2: Cover Opening and Electrode Sticking

In the test example, the discharged waste lithium-ion batteries of E1 to E28, C1 to C6, and C10 to 13 were used as the test samples. The aluminum safety vent on the upper end cover of the discharged waste lithium-ion battery was observed with the naked eyes to determine whether it had been corroded by discharge solutions to make the upper end cover opened. If the upper end covers opened after being immersed in the discharge solutions for a period of time, it would be indicated by “o” in Table 1 and Table 2 below. If the upper end covers remained closed after being immersed in the discharge solutions for a period of time without being opened, it would be indicated by “x” in Table 1 and Table 2 below.

As shown in Table 1, after 36 hours of discharge treatment in E1 to E28, the aluminum safety vents on the upper end covers were all corroded by the discharge solutions and the covers were opened, ensuring the subsequent disposal of waste lithium-ion batteries without safety concerns and facilitating to omit the subsequent disassembly of lithium-ion batteries. On the contrary, the covers of the waste lithium-ion batteries in C1, C3, C5, and C10 to C13 were not opened after 36 hours of discharge, and the waste lithium-ion battery in C6 has not been opened even after a longer immersing and discharging process. As a result, these waste lithium-ion batteries are still dangerous in subsequent processes, and a sufficient external force is still required to remove the battery casing after discharge, so that other components with economic values of the battery can be recycled.

In addition, for the lithium-ion batteries with cover opening, i.e., E1 to E28, C2, and C4, the batteries were further observed with the naked eyes whether the penetration of the discharge solutions into the interior of the waste lithium-ion batteries caused serious electrode sticking problems, increasing the difficulties of subsequent electrode isolation and material purification. The results were shown in Table 1 and Table 2 below. It can be understood that if a waste lithium-ion battery has not been opened after immersion, it means that the discharge solution would not penetrate into the interior of the waste lithium-ion battery, and there was no need to evaluate whether the discharge solution would penetrate into the battery and cause the electrode sticking or either the positive electrode terminal or positive electrode tab to be corroded and dissolved, so it was marked “N/A” (not available) in Table 1 and Table 2 below.

When it was observed that extensive positive and negative electrode materials were adhered to the isolation film, it means that serious electrode sticking occurred, which would significantly increase the difficulties of subsequent electrode isolation and material purification, and it was indicated by “x” in Table 1 and Table 2 below. When the positive electrode was slightly adhered to the isolation film at 3 mm or below, it means that slight electrode sticking occurred and the difficulties of electrode isolation and material purification were not excessively caused, so it was indicated by “Δ” in Table 1 and Table 2 below. When the positive and negative electrodes were not adhered to the isolation film, it means that no electrode sticking occurred and the difficulties of electrode isolation and material purification were not caused, and it was indicated by “◯” in Table 1 and Table 2 below.

As shown in Table 1 and Table 2 below, the discharge solutions used in E1 to E28 could corrode the aluminum safety vents and open the covers, and would not cause serious electrode sticking problems when penetrating into the interior of the batteries. On the contrary, C2 (using NaCl as the discharge solution) and C4 (using Na₂SO₄ as the discharge solution) could cause opened covers after extending the discharge time, but serious electrode sticking occurred, and the discharge solutions turned into black solutions after immersing for a long time. It can be seen that the surface of the positive terminal and the battery inner coil were corroded by the NaCl solution and the Na₂SO₄ solution, causing the positive terminal or the positive tab to dissolve. From further observation, it could be seen in C2 that yellow iron diffused into the isolation film and the positive terminal was completely dissolved; and it was also observed that the positive terminal of C4 was seriously dissolved. Since the covers in C1, C3, C5, C6, and C10 to C13 were not opened, there was no need to discuss whether the discharge solutions would penetrate into the batteries and cause the electrode sticking problems.

### Test Example 3: PH Values

In the test example, the pH values of the discharge solutions before and after discharge of E1 to E28 were measured. The results were recorded in Table 1 and Table 2 below.

As shown in Table 1 and Table 2 below, there were no significant changes of the pH values before and after discharge of E1 to E28. It can be seen that these used discharge solutions could be recycled and reused to continue the discharge process of the next batch of waste lithium-ion batteries.

TABLE 1
Discharge solutions and discharge time in E1 to E20 and C1 to C9 to discharge batteries
with high residual voltage; voltage and pH values of the discharge solutions before
and after discharge; cover opening (CO) and sticking (ST) evaluation after discharge

| | | | | Voltage (V) | | pH value | | | |
|---|---|---|---|---|---|---|---|---|---|
| | Discharge | Discharge | | Before | After | Before | After | Evaluation | |
| No. | solution | time | | discharge | discharge | discharge | discharge | CO | ST |
| E1 | A | 36 | hr | 3.56 | −0.85 | 13.29 | 13.07 | ∘ | ∘ |
| E2 | A | 36 | hr | 4.08 | −1.46 | 13.29 | 13.07 | ∘ | ∘ |
| E3 | B | 36 | hr | 3.56 | −0.402 | 13.52 | 13.38 | ∘ | Δ |
| E4 | B | 36 | hr | 4.08 | −0.456 | 13.52 | 13.38 | ∘ | Δ |
| E5 | C | 36 | hr | 3.13 | −0.215 | 13.75 | 13.73 | ∘ | Δ |
| E6 | D | 36 | hr | 3.57 | −0.484 | 13.11 | 13.00 | ∘ | ∘ |
| E7 | D | 36 | hr | 4.08 | −0.331 | 13.11 | 13.00 | ∘ | Δ |
| E8 | E | 36 | hr | 3.63 | −0.402 | 13.29 | 13.30 | ∘ | Δ |
| E9 | E | 36 | hr | 3.56 | −0.209 | 13.29 | 13.30 | ∘ | Δ |
| E10 | E | 36 | hr | 4.08 | −0.278 | 13.29 | 13.30 | ∘ | Δ |
| E11 | F | 36 | hr | 3.56 | −0.696 | 13.31 | 13.25 | ∘ | Δ |
| E12 | F | 36 | hr | 4.1 | −0.294 | 13.31 | 13.25 | ∘ | ∘ |
| E13 | G | 36 | hr | 3.56 | −0.2 | 13.62 | 13.66 | ∘ | ∘ |
| E14 | G | 36 | hr | 3.56 | −0.127 | 13.62 | 13.66 | ∘ | ∘ |
| E15 | G | 36 | hr | 4.09 | −0.257 | 13.62 | 13.66 | ∘ | Δ |
| E16 | H | 36 | hr | 2.99 | −0.556 | 13.52 | 13.66 | ∘ | ∘ |
| E17 | H | 36 | hr | 3.56 | −0.299 | 13.52 | 13.66 | ∘ | Δ |
| E18 | H | 36 | hr | 4.1 | −0.458 | 13.52 | 13.66 | ∘ | Δ |
| E19 | I | 36 | hr | 3.56 | −0.626 | 13.46 | 13.41 | ∘ | Δ |
| E20 | I | 36 | hr | 0.565 | 0.289 | 13.46 | 13.41 | ∘ | ∘ |
| C1 | NaCl | 36 | hr | 3.57 | 3.45 | 8.15 | — | x | N/A |
| C2 | NaCl | 144 | hr | 3.57 | −0.625 | 8.15 | — | ∘ | x |
| C3 | Na₂SO₄ | 36 | hr | 3.57 | 3.55 | 6.47 | — | x | N/A |
| C4 | Na₂SO₄ | 144 | hr | 3.57 | 0.205 | 6.47 | — | ∘ | x |
| C5 | K₂HPO₄ | 36 | hr | 3.57 | 3.53 | 9.15 | — | x | N/A |
| C6 | K₂HPO₄ | 144 | hr | 3.57 | 2.222 | 9.15 | — | x | N/A |
| C7 | Citric acid | 36 | hr | 4.12 | 3.88 | — | — | — | — |
| C8 | Sodium carbonate | 36 | hr | 4.12 | 3.67 | — | — | — | — |
| C9 | Oxalic acid | 36 | hr | 4.12 | 3.76 | — | — | — | — |

TABLE 2
Discharge solutions and discharge time in E21 to E28 and C10 to C13
to discharge batteries with high residual voltage; voltage and pH
values of the discharge solutions before and after discharge; cover
opening (CO) and sticking (ST) evaluation after discharge.

| | | | | Voltage (V) | | pH value | | | |
|---|---|---|---|---|---|---|---|---|---|
| | Discharge | Discharge | | Before | After | Before | After | Evaluation | |
| No. | solution | time | | discharge | discharge | discharge | discharge | CO | ST |
| E21 | A | 36 | hr | 0.841 | −0.55 | 13.29 | 13.07 | ∘ | ∘ |
| E22 | B | 36 | hr | 0.001 | −0.393 | 13.52 | 13.38 | ∘ | Δ |
| E23 | C | 36 | hr | 0.075 | −0.064 | 13.75 | 13.73 | ∘ | Δ |
| E24 | D | 36 | hr | 0.001 | −0.108 | 13.11 | 13.00 | ∘ | Δ |
| E25 | E | 36 | hr | 0.459 | −0.336 | 13.29 | 13.30 | ∘ | Δ |
| E26 | F | 36 | hr | 0.59 | −0.196 | 13.31 | 13.25 | ∘ | Δ |
| E27 | H | 36 | hr | 0.771 | −0.267 | 13.52 | 13.66 | ∘ | Δ |
| E28 | I | 36 | hr | 0.565 | 0.289 | 13.46 | 13.41 | ∘ | ∘ |
| C10 | NaCl | 36 | hr | 0.505 | 0.196 | 8.15 | — | x | N/A |
| C11 | Na₂SO₄ | 36 | hr | 0.487 | 0.27 | 6.47 | — | x | N/A |
| C12 | K₂HPO₄ | 36 | hr | 0.491 | 0.481 | 9.15 | — | x | N/A |
| C13 | K₂HPO₄ | 144 | hr | 0.491 | 0.477 | 9.15 | — | x | N/A |

### Test Example 4: Metal Ion Dissolution Rate

In the test example, the discharge solutions after immersing the waste lithium-ion batteries in the aforementioned examples and comparative examples were collected as recovery solutions, and the recovery solutions of equal amounts were analyzed by X-ray fluorescence (XRF) method to obtain the content of iron ions and nickel ions in each recovery solution. The results of XRF analysis were expressed in unit of counts per second (cps)), and were shown in Table 3 below.

The higher the cps analyzed by XRF, the higher the metal content. Comparing the metal contents in the same amount of recovery solutions can evaluate whether large amounts of metal ions were dissolved during the discharge process with different discharge solutions, and determine whether difficulties in subsequent wastewater recycling and metal purification were brought.

TABLE 3
The content of iron and nickel ions in recovery solutions
(RE) recovered from the discharge solutions of E1
to E4, E8 to E10, E13 to E15, C1, and C3.

| | | Discharge | Fe | Ni |
|---|---|---|---|---|
| No. | Source | solution | (cps) | (cps) |
| RE1 | E1 and E2 | A | 14574.2 | 966.8 |
| RE2 | E3 andE4 | B | 9881.9 | 945.2 |
| RE3 | E8 to E10 | E | 4939.6 | 969.5 |
| RE4 | E13 to E15 | G | 267.8 | 58.1 |
| RE5 | C1 | NaCl | 87381.8 | 729.0 |
| RE6 | C3 | Na₂SO₄ | 322266.8 | 3288.0 |

As shown in Table 3 above, when equal amounts of recovery solution 1 to recovery solution 6 were used to analyze components, the content of iron ions in recovery solution 1 to recovery solution 4 was significantly lower than that in recovery solution 5 and recovery solution 6, and the content of nickel ions in recovery solution 1 to recovery solution 4 was also significantly lower than that of nickel ions in recovery solution 6. It can be seen that, compared with NaCl or Na₂SO₄ solution, discharge solutions A, B, E, and G not only offer many of the aforementioned advantages but also better inhibit the dissolution rate of metal ions during the discharge process, thereby avoiding the troubles of subsequent wastewater recycling after discharge.

In summary, the discharge method of the present invention for lithium-ion batteries can efficiently and safely discharge waste lithium-ion batteries, and the discharge solutions can open the upper end cover while discharging, and solve the problems of subsequent recycling and disposing difficulties due to electrode sticking or corrosions and dissolutions of positive electrode terminals or positive electrode tabs caused by conventional discharge process. The method greatly improves the safety and simplicity of recycling and reprocessing of waste lithium-ion batteries.

Even though numerous characteristics and advantages of the present invention have been set forth in the foregoing description, together with details of the technical means and features of the invention, the disclosure is illustrative only. Changes may be made in the details within the principles of the invention to the full extent indicated by the broad general meaning of the terms in which the appended claims are expressed.

What is claimed is:

1. A method for discharging a lithium-ion battery, comprising placing a lithium-ion battery to be discharged in a discharge solution to obtain a discharged lithium-ion battery, wherein the discharge solution includes 0.5 M to 2 M of an alkaline solution and 0.1 M to 3 M of an auxiliary agent, and the auxiliary agent includes acetate, citrate, chloride, sulfate, phosphate, oxalate, an organic acid, or any combinations thereof.

2. The method as claimed in claim 1, wherein the organic acid includes formic acid, oxalic acid, ethylenediaminetetraacetic acid, methanesulfonic acid, ethanesulfonic acid, propanesulfonic acid, butanesulfonic acid, lactic acid, tartaric acid, gluconic acid, glycine, glutamic acid, succinic acid, or any combinations thereof.

3. The method as claimed in claim 1, wherein the alkaline solution includes sodium hydroxide solution, potassium hydroxide solution, calcium hydroxide solution, or any combinations thereof.

4. The method as claimed in claim 1, wherein a mass ratio of the discharge solution to the lithium-ion battery to be discharged is 1:0.5 to 1:5.

5. The method as claimed in claim 1, wherein the pH value of the discharge solution is 13 or above.

6. The method as claimed in claim 1, wherein a voltage of the discharged lithium-ion battery is 1 volt or less.

7. The method as claimed in claim 1, wherein a change rate of a voltage of the discharged lithium-ion battery after one day of discharge is 3% or less.

8. The method as claimed in claim 1, wherein a discharge time of placing the lithium-ion battery to be discharged in the discharge solution is 12 hours to 240 hours.

9. The method as claimed in claim 1, wherein a concentration of the chloride in the discharge solution is 0.01 M to 0.20 M.

10. The method as claimed in claim 1, wherein a positive electrode and a negative electrode of the lithium-ion battery to be discharged are placed in the discharge solution and in direct contact with the discharge solution for discharging.

11. The method as claimed in claim 1, wherein the lithium-ion battery to be discharged has an aluminum safety vent and a current interrupt device, the aluminum safety vent is disposed under a positive electrode of the lithium-ion battery to be discharged, and the current interrupt device is disposed under the aluminum safety vent.
